(19) United States
(12) Patent Application Publication
(10) Pub. No.: US 2014/0305647 A1
(43) Pub. Date: Oct. 16, 2014

(54) METHODS OF PRODUCING FRICTION REDUCING BIOSYNTHETIC POLYSACCHARIDES

(71) Applicant: Halliburton Energy Services, Inc., Houston, TX (US)

(72) Inventors: Jimmie D. Weaver, Duncan, OK (US); David Loveless, Houston, TX (US); Nathan Carl Schultheiss, Houston, TX (US); Ali Alwattari, Houston, TX (US)

(73) Assignee: Halliburton Energy Services, Inc., Houston, TX (US)

(21) Appl. No.: 14/224,578

(22) Filed: Mar. 25, 2014

Related U.S. Application Data
(60) Provisional application No. 61/811,442, filed on Apr. 12, 2013.

(51) Int. Cl. C09K 8/00; C09K 8/035; E21B 43/16; E21B 43/25

(52) U.S. Cl. CPC C09K 8/00; E21B 43/25; C09K 8/035; E21B 43/16
USPC 166/305.1; 507/110; 507/211; 507/213

(57) ABSTRACT

Methods of treating a subterranean formation including providing a treatment fluid comprising an aqueous base fluid and a friction reducing agent, wherein the friction reducing agent is a biosynthetic polysaccharide produced by a host cell line with DNA encoding the biosynthetic polysaccharide; and introducing the treatment fluid into the subterranean formation.

### BACKGROUND

The present disclosure relates to methods of producing friction reducing biosynthetic polysaccharides.

Subterranean formation treatment operations (e.g., drilling operations, completion operations, stimulation operations, and the like) involve pumping treatment fluids through pumping equipment, tubular equipment (e.g., coiled tubing, pipes, and the like) and formation openings (e.g., fractures, perforations, pores, and the like). A considerable amount of energy may be lost due to frictional forces between turbulent flow of treatment fluids and the formation and/or tubular equipment. The energy loss is manifested by a pressure drop in moving the treatment fluid through a given distance and is directly proportional to the velocity of the fluid. Because of the energy loss, additional surface energy (e.g., equipment with greater horsepower) may be necessary to perform the desired treatment operation. Moreover, the frictional forces can, among other things, impact well design and/or limit horizontal drill lengths. In addition, energy loss is increased by any irregularities in the tubular equipment or subterranean formation. To reduce frictional forces and the associated energy loss, friction reducing polymers are typically included in treatment fluids for use in formation treatment operations.

Friction reducing polymers alter the rheological properties of a treatment fluid to reduce friction created within the fluid as it flows through equipment, tubulars, and the subterranean formation itself. Traditional friction reducing polymers are chemically synthesized or procured from scarce natural resources. As such, traditional friction reducing polymers are typically very expensive and can be cost prohibitive for use in some formation treatment operations, particularly because a large concentration of such polymers are required in many formation treatment operations. Therefore, a method of producing large quantities of friction reducing polymers that are not cost prohibitive in the industry may be of benefit to one of ordinary skill in the art.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 depicts an embodiment of a system configured for delivering the treatment fluids of the embodiments described herein to a downhole location.

### DETAILED DESCRIPTION

The present disclosure relates to methods of producing friction reducing biosynthetic polysaccharides. In particular, the present disclosure relates to methods of producing friction reducing biosynthetic polysaccharides utilizing enzyme technology; fungal technology; transgenic technology; and any combination thereof. In addition to the friction reducing capacity of the biosynthetic polysaccharides of the present disclosure, they may additionally aid in viscosifying treatment fluids used in subterranean formation operations.

As used herein, the term “biosynthetic polysaccharides” refers to polysaccharides that are produced by biosynthetic pathways, either naturally or by physical manipulation of an organism to induce such polysaccharides. The biosynthetic polysaccharides of the present disclosure can be produced in commercial quantities and in an environmentally friendly and sustainable manner. Moreover, because of their method of production, they may be manipulated to possess certain qualities beneficial to particular formation treatment operations or enhance generally preferred qualities (e.g., extensional viscosity, low drag when dispersed in treatment fluids, sufficient molecular weight to withstand high shear, and the like).

The methods of the present disclosure involve the use of organisms to produce the biosynthetic polysaccharides of the present disclosure. The organisms may be themselves equipped to produce polysaccharides (i.e., naturally) or may be biologically altered to produce polysaccharides or to produce them in a different manner (e.g., faster or in a way that facilitates purification). The organisms of the present disclosure may be manipulated by enzyme technology, fungal technology, and/or transgenic technology. As used herein, the term “enzyme technology” refers to the process of modifying an enzyme's structure, modifying an enzyme's catalytic activity, and/or modifying the availability of an enzyme so as to cause it to function in a desirable manner (e.g., to produce certain metabolites, to catalyze particular reactive pathways, bio-transform certain compounds, and the like). Enzyme technology may be used in any biological organism (e.g., bacteria, fungi, plants, and the like) and is particularly beneficial when the organism naturally produces the desired biosynthetic polysaccharide. As used herein, the term “fungal technology” refers to the growth of a fungus to produce a desired product, such as the biosynthetic polysaccharides of the present disclosure. As used herein, the term “transgenic technology” refers to genetically altering a plant species to produce a desired product, such as the biosynthetic polysaccharides of the present disclosure.

Although some embodiments described herein are illustrated by reference to drilling, fracturing, and gravel packing operations, the friction reducing biosynthetic polysaccharides disclosed herein may be used in any subterranean formation operation that may benefit from their friction reducing properties. Such treatment operations may include, but are not limited to, a stimulation operation; an acidizing operation; an acid-fracturing operation; a sand control operation; a frac-packing operation; a remedial operation; a near-wellbore consolidation operation; and any combination thereof.

Moreover, the friction reducing biosynthetic polysaccharides described herein may be used in any non-subterranean operation that may benefit from their friction reducing properties. Such operations may be performed in any industry including, but not limited to, oil and gas, mining, chemical, pulp and paper, aerospace, medical, automotive, and the like.

One or more illustrative embodiments disclosed herein are presented below. Not all features of an actual implementation are described or shown in this application for the sake of clarity. It is understood that in the development of an actual embodiment incorporating the embodiments disclosed herein, numerous implementation-specific decisions must be made to achieve the developer's goals, such as compliance with system-related, lithology-related, business-related, government-related, and other constraints, which vary by implementation and from time to time. While a developer's efforts might be complex and time-consuming, such efforts would be, nevertheless, a routine undertaking for those of ordinary skill the art having benefit of this disclosure.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps. When “comprising” is used in a claim, it is open-ended.

In some embodiments, the present disclosure provides for a method of treating a subterranean formation by introducing into the subterranean formation a treatment fluid comprising an aqueous base fluid and a friction reducing agent, wherein the friction reducing agent is a biosynthetic polysaccharide produced by a host cell line with DNA encoding the biosynthetic polysaccharide (e.g., the host cell line may naturally produce the DNA encoding the biosynthetic polysaccharide or may be transfected with the DNA encoding the biosynthetic polysaccharide). The host cell line may include a prokaryotic cell line or a eukaryotic cell line, including bacterial cells, fungal cells, plant cells, and animal cells. The cell line may be any cell line capable of accepting DNA capable of encoding the desired biosynthetic polysaccharide.

In some embodiments, the host cell line is a bacterial cell line including aerobic and anaerobic bacteria. In some preferred embodiments, the host cell line is a bacterial cell line of facultative anaerobic bacteria. Specific bacterial cell lines that may be used in the methods of the present disclosure include, but are not limited to, bacteria from the genera Aeromonas; Plesiomonas; Pseudomonas; Sphingomonas; Gluconacetobacter; Streptococcus; Xanthomonas; Leuconostoc; Alcaligenes; Klebsiella; Enterobacter; and any combination thereof. In other embodiments, the host cell line is a fungal cell line including aerobic and anaerobic fungi. Specific fungal cell lines that may be used in the methods of the present disclosure include, but are not limited to, fungi from the genera Sclerotium; Sderotinia; Corticum; Helotium; Stromatinia; Schizophyllum; Calviceps; Tremella; Aureobasidium; and any combination thereof. In yet other embodiments, the host cell line is a plant cell line that produces a monocotyledonous plant or a dicotyledonous plant. Specific examples of plant cell lines may include, but are not limited to, plant cell lines from the plant genera Coffea; Lolium; Solanum; Zea; Triticum; Oryza; Manihot; Cyamopsis; Ceratonia; Caesalpinia; Trigonella; Gossypium; Phytelephas; Delonix; Faboideae; and any combination thereof. In those embodiments where a plant cell line is used in the methods of the present disclosure, it may be desirable to grow the plant to maturity, but that is not necessary to practice the methods disclosed herein. In still other embodiments, the host cell line may be an animal cell line that is either mammalian or non-mammalian. Specific animal cell lines than may be used in the methods of the present disclosure include, but are not limited to, pig; mouse; rat; hamster; chicken; fish; and insect.

The DNA encoding the biosynthetic polysaccharides described herein may include, but is not limited to, DNA encoding scleroglucan; xanthan; diutan; galactomannan; amylopectin; carrageenan; inulin; polypectate; tragacanth; and any combination thereof. When transfecting a host cell line with the DNA, it may be a full unspliced DNA comprising coding exons and non-coding introns or a spliced DNA comprising only coding exons. The DNA may be transfected into the host cell line by any method known in the art including, but not limited to, biologically; chemically; physically; and any combination thereof. The host cell line after transfection may be cultured by any known method in the art. The culture media and method may vary, for example, with the host cell line type, the type of biosynthetic polysaccharide produced, the environmental culture conditions, and the like.

In some embodiments, enzyme technology is used to increase production of a host cell line's production of a desired biosynthetic polysaccharide, which may either be naturally produced by the cell line and/or genetically modified so as to be produced. The host cell line may be treated with an enzyme that enhances the production of the desired biosynthetic polysaccharide, such as by catalyzing the biological pathways that produce it. For example, if the host cell line is from the genus Coffea and the desired biosynthetic polysaccharide is galactomannan, the enzymes galactosyltransferase and mannan synthase, which participate in the biosynthetic pathway for modulation of galactomannan in Coffea, may be upregulated by enzyme technology (e.g., by increasing expression of the gene encoding the enzyme, by introducing a transgene encoding the enzyme, or manipulating the enzyme such that it is always “on”). Any enzyme technology known in the art that may increase the synthesis of the biosynthetic polysaccharides may be used in the methods of the present disclosure.

In some embodiments, the present disclosure provides a method of purifying the biosynthetic polysaccharides of the present disclosure. Unwanted proteins and nucleic acids may be first precipitated and separated from the host cell line, followed by precipitation and isolation of the biosynthetic polysaccharides. Purification may be performed by any method known in the art including, for example, commercially available purification kits. In some embodiments, for example, the purification may utilize RNAse, DNAse, or protease to remove contamination with host cell line nucleic acids and proteins.

In some embodiments, the purification may include a diafiltration step (e.g., by tangential flow diafiltration) after unwanted proteins and nucleic acids are precipitated and removed but prior to precipitation and isolation of the biosynthetic polysaccharides. As defined herein, the term “diafiltration” refers to the use of ultrafiltration membranes to remove salts or other microsolutes from a solution. In some embodiments, the purified biosynthetic polysaccharides may be further decontaminated by known methods in the art (e.g., by centrifugation in an alcohol).

In some embodiments, the biosynthetic polysaccharides of the present disclosure may be introduced into a treatment fluid for use in a subterranean formation operation after purification. The purified biosynthetic polysaccharides of the present disclosure may be present in the treatment fluid in an amount in the range of from about 0.1% to about 80% by weight of the treatment fluid.

In other embodiments, such as where the host cell line naturally produces the biosynthetic polysaccharide or has been transfected with DNA encoding the biosynthetic polysaccharide and has not grown to maturity (i.e., has not been grown into a plant but remains a cultured cell line), the host cell line containing the biosynthetic polysaccharides may be added directly to the treatment fluid without a purification step. This method may be preferred when time constraints are placed on a particular subterranean operation or when economic constraints are applicable to a particular purification method. In those embodiments where the host cell line is directly added to the treatment fluid, the host cell line may be present in an amount equivalent to produce purified biosynthetic polysaccharides in an amount in the range of from about 0.1% to about 80% by weight of the treatment fluid. That is, the host cell line may be present in an amount of up to about 50% greater than the range of equivalent purified biosynthetic polysaccharide to be added to the treatment fluid. This may be preferred so as to ensure adequate friction reducing properties. Factors that may affect the amount of host cell line to be added to the treatment fluid may include, but are not limited to, temperature, pressure, downhole conditions, and the like. One of ordinary skill in the art, with the benefit of this disclosure, will recognize the appropriate amount of bacteria to include in the treatment fluids of the present disclosure to achieve a particular result.

The treatment fluid may be a drilling fluid, a fracturing fluid, a gravel packing fluid, or any other treatment fluid that may benefit from a friction reducing agent. The treatment fluids of the present disclosure comprise an aqueous base fluid and may be used to resolubilize isolated and purified biosynthetic polysaccharides, for example. Suitable aqueous base fluids for use in the treatment fluids of the present disclosure may comprise fresh water; saltwater (e.g., water containing one or more salts dissolved therein); brine (e.g., saturated salt water); seawater; or combinations thereof. Generally, the water may be from any source, provided that it does not contain components that might adversely affect the stability and/or performance of the treatment fluids comprising the biosynthetic polysaccharides of the present disclosure. In certain embodiments, the viscosity of the aqueous base fluid can be adjusted, among other purposes, to provide additional particulate transport and suspension in the treatment fluids used in the methods of the present disclosure. In certain embodiments, the pH of the aqueous base fluid may be adjusted (e.g., by a buffer or other pH adjusting agent), to adjust the viscosity. One of ordinary skill in the art, with the benefit of this disclosure, will recognize when such viscosity and/or pH adjustments are appropriate. In some embodiments, the pH range may preferably be from about 4 to about 11.

The treatment fluids of the present disclosure may further comprise an additive suited to the particular subterranean formation operation for which the treatment fluid is to be used. Suitable additives include, but are not limited to, a salt; a weighting agent; an inert solid; a fluid loss control agent; a corrosion inhibitor; a gelling agent; a surfactant; a particulate; a proppant; a gravel particulate; a lost circulation material; a foaming agent; a gas; a pH control additive; a breaker; a biocide; a stabilizer; a scale inhibitor; a friction reducer; a clay stabilizing agent; a crosslinking agent; and any combination thereof.

In various embodiments, systems configured for delivering the treatment fluids described herein to a downhole location are described. In various embodiments, the systems can comprise a pump fluidly coupled to a tubular, the tubular containing the treatment fluids described herein.

The pump may be a high pressure pump in some embodiments. As used herein, the term “high pressure pump” will refer to a pump that is capable of delivering a fluid downhole at a pressure of about 1000 psi or greater. A high pressure pump may be used when it is desired to introduce the treatment fluids to a subterranean formation at or above a fracture gradient of the subterranean formation, but it may also be used in cases where fracturing is not desired. In some embodiments, the high pressure pump may be capable of fluidly conveying particulate matter, such as the non-degradable particulates, the degradable particulates, and the proppant particulates described in some embodiments herein, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the treatment fluids to the high pressure pump. In such embodiments, the low pressure pump may “step up” the pressure of the treatment fluids before reaching the high pressure pump.

In some embodiments, the systems described herein can further comprise a mixing tank that is upstream of the pump and in which the treatment fluids are formulated. In various embodiments, the pump (e.g., a low pressure pump, a high pressure pump, or a combination thereof) may convey the treatment fluids from the mixing tank or other source of the treatment fluids to the tubular. In other embodiments, however, the treatment fluids may be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluids may be drawn into the pump, elevated to an appropriate pressure, and then introduced into the tubular for delivery downhole.

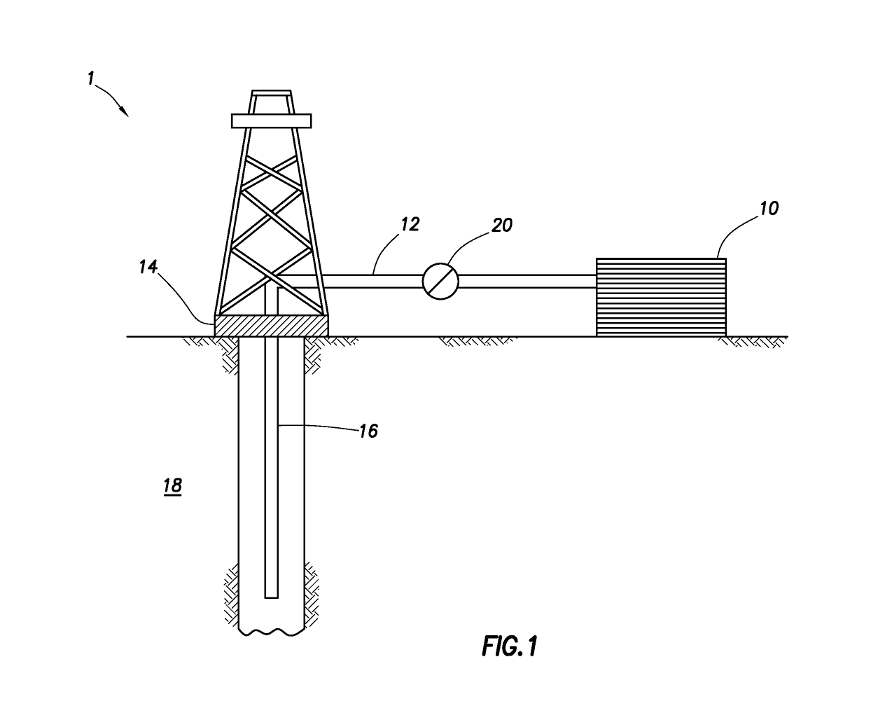

FIG. 1 shows an illustrative schematic of a system that can deliver the treatment fluids of the present disclosure to a downhole location, according to one or more embodiments. It should be noted that while FIG. 1 generally depicts a land-based system, it is to be recognized that like systems may be operated in subsea locations as well. As depicted in FIG. 1, system 1 may include mixing tank 10, in which the treatment fluids of the embodiments herein may be formulated. The treatment fluids may be conveyed via line 12 to wellhead 14, where the treatment fluids enter tubular 16, tubular 16 extending from wellhead 14 into subterranean formation 18. Upon being ejected from tubular 16, the treatment fluids may subsequently penetrate into subterranean formation 18. Pump 20 may be configured to raise the pressure of the treatment fluids to a desired degree before introduction into tubular 16. It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 1, the treatment fluid may, in some embodiments, flow back to wellhead 14 and exit subterranean formation 18. In some embodiments, the treatment fluid that has flowed back to wellhead 14 may subsequently be recovered and recirculated to subterranean formation 18.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

Embodiments Disclosed Herein Include:

A. A method comprising: providing a treatment fluid comprising an aqueous base fluid and a friction reducing agent, wherein the friction reducing agent is a biosynthetic polysaccharide produced by a host cell line with DNA encoding the biosynthetic polysaccharide; and introducing the treatment fluid into a subterranean formation.

B. A method comprising: providing a treatment fluid comprising an aqueous base fluid; providing a friction reducing agent comprising a biosynthetic polysaccharide produced by a host cell line with DNA encoding the biosynthetic polysaccharide; purifying the biosynthetic polysaccharide so as to produce a purified friction reducing agent; introducing the purified friction reducing agent into the treatment fluid; and introducing the treatment fluid into a subterranean formation.

Each of embodiments A and B may have one or more of the following additional elements in any combination:

Element 1: A host cell line selected from the group consisting of a prokaryotic cell line; a eukaryotic cell line; and any combination thereof.

Element 2: A prokaryotic host cell line that is a bacterial cell line selected from the group consisting of Aeromonas; Plesiomonas; Pseudomonas; Sphingomonas; Gluconacetobacter; Streptococcus; Xanthomonas; Leuconostoc; Alcaligenes; Klebsiella; Enterobacter; and any combination thereof.

Element 3: A eukaryotic host cell line that is a fungal cell line selected from the group consisting of Sclerotium; Scierotinia; Corticum; Helotium; Stromatinia; Schizophyllum; Calviceps; Tremella; Aureobasidium; and any combination thereof.

Element 4: A eukaryotic host cell line that is an animal cell line selected from the group consisting of pig; mouse; rat; hamster; chicken; fish; and insect.

Element 5: A eukaryotic host cell line that is a plant cell line that produces a monocotyledonous plant or a dicotyledonous plant.

Element 6: A eukaryotic host cell line that is a plant cell line selected from the group consisting of Coffea; Lolium; Solanum; Zea; Triticum; Oryza; Manihot; Cyamopsis; Ceratonia; Caesalpinia; Trigonella; Gossypium; Phytelephas; Delonix; Faboideae; and any combination thereof.

Element 7: The biosynthetic polysaccharide is selected from the group consisting of scleroglucan; xanthan; diutan; galactomannan; and any combination thereof.

Element 8: The treatment fluid is used in at least one of a drilling operation; a fracturing operation; and a gravel packing operation.

Element 9: The concentration of the biosynthetic polysaccharide is increased by manipulating at least one enzyme involved in production of the biosynthetic polysaccharide by the host cell line.

Element 10: The treatment fluid further comprises an additive selected from the group consisting of a salt; a weighting agent; an inert solid; a fluid loss control agent; a corrosion inhibitor; a gelling agent; a surfactant; a particulate; a proppant; a gravel particulate; a lost circulation material; a foaming agent; a gas; a pH control additive; a breaker; a biocide; a stabilizer; a scale inhibitor; a friction reducer; a clay stabilizing agent; a crosslinking agent; and any combination thereof.

Element 11: The DNA encodes scleroglucan; xanthan; diutan; galactomannan; amylopectin; carrageenan; inulin; polypectate; tragacanth; and any combination thereof.

Element 12: Further comprising a wellhead with a tubular extending therefrom and into the subterranean formation, and a pump fluidly coupled to the tubular, wherein the step of: introducing the treatment fluid into the subterranean formation comprises introducing the treatment fluid through the wellbore.

By way of non-limiting example, exemplary combinations applicable to A and B include: A in combination with 2 and 11; A in combination with 3, 8, and 9; or B in combination with 6, 7, 10, and 12.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
providing a treatment fluid comprising an aqueous base fluid and a friction reducing agent,
wherein the friction reducing agent is a biosynthetic polysaccharide produced by a host cell line with DNA encoding the biosynthetic polysaccharide; and
introducing the treatment fluid into a subterranean formation.

2. The method of claim 1, wherein the host cell line is selected from the group consisting of a prokaryotic cell line; a eukaryotic cell line; and any combination thereof.

3. The method of claim 2, wherein the prokaryotic cell line is a bacterial cell line selected from the group consisting of Aeromonas; Plesiomonas; Pseudomonas; Sphingomonas; Gluconacetobacter; Streptococcus; Xanthomonas; Leuconostoc; Alcaligenes; and any combination thereof.

4. The method of claim 2, wherein the eukaryotic cell line is a fungal cell line selected from the group consisting of Sclerotium; Scierotinia; Corticum; Helotium; Stromatinia; Schizophyllum; Calviceps; Tremella; Aureobasidium; and any combination thereof.

5. The method of claim 2, wherein the eukaryotic cell line is an animal cell line selected from the group consisting of pig; mouse; rat; hamster; chicken; fish; and insect.

6. The method of claim 2, wherein the eukaryotic cell line is a plant cell line that produces a monocotyledonous plant or a dicotyledonous plant.

7. The method of claim 6, wherein the plant cell line is selected from the group consisting of Coffea; Lolium; Solanum; Zea; Triticum; Oryza; Manihot; Cyamopsis; Ceratonia; Caesalpinia; Trigonella; Gossypium; Phytelephas; Delonix; Faboideae; and any combination thereof.

8. The method of claim 1, wherein the biosynthetic polysaccharide is selected from the group consisting of scleroglucan; xanthan; diutan; galactomannan; and
any combination thereof.

9. The method of claim 1, wherein a concentration of the biosynthetic polysaccharide is increased by manipulating at least one enzyme involved in production of the biosynthetic polysaccharide by the host cell line.

10. The method of claim 1, further comprising a wellhead with a tubular extending therefrom and into the subterranean formation, and a pump fluidly coupled to the tubular,
wherein the step of: introducing the treatment fluid into the subterranean formation comprises introducing the treatment fluid through the wellbore.

11. A method comprising:
providing a treatment fluid comprising an aqueous base fluid;
providing a friction reducing agent comprising a biosynthetic polysaccharide produced by a host cell line with DNA encoding the biosynthetic polysaccharide;
purifying the biosynthetic polysaccharide so as to produce a purified friction reducing agent;
introducing the purified friction reducing agent into the treatment fluid; and
introducing the treatment fluid into a subterranean formation.

12. The method of claim 11, wherein the host cell line is selected from the group consisting of a prokaryotic cell line; a eukaryotic cell line; and any combination thereof.

13. The method of claim 12, wherein the prokaryotic cell line is a bacterial cell line selected from the group consisting of Aeromonas; Plesiomonas; Pseudomonas; Sphingomonas; Gluconacetobacter; Streptococcus; Xanthomonas; Leuconostoc; Alcaligenes; and any combination thereof.

14. The method of claim 12, wherein the eukaryotic cell line is a fungal cell line selected from the group consisting of Sclerotium; Scierotinia; Corticum; Helotium; Stromatinia; Schizophyllum; Calviceps; Tremella; Aureobasidium; and any combination thereof.

15. The method of claim 12, wherein the eukaryotic cell line is an animal cell line selected from the group consisting of pig; mouse; rat; hamster; chicken; fish; and insect.

16. The method of claim 12, wherein the eukaryotic cell line is a plant cell line that produces a monocotyledonous plant or a dicotyledonous plant.

17. The method of claim 16, wherein the plant cell line is selected from the group consisting of Coffea; Lolium; Solanum; Zea; Triticum; Oryza; Manihot; Cyamopsis; Ceratonia; Caesalpinia; Trigonella; Gossypium; Phytelephas; Delonix; Faboideae; and any combination thereof.

18. The method of claim 11, wherein the biosynthetic polysaccharide is selected from the group consisting of scleroglucan; xanthan; diutan; galactomannan; and any combination thereof.

19. The method of claim 11, wherein a concentration of the biosynthetic polysaccharide is increased by manipulating at least one enzyme involved in production of the biosynthetic polysaccharide by the host cell line.

20. The method of claim 11, further comprising a wellhead with a tubular extending therefrom and into the subterranean formation, and a pump fluidly coupled to the tubular,
wherein the step of: introducing the treatment fluid into the subterranean formation comprises introducing the treatment fluid through the wellbore.
